(19) United States
(12) Patent Application Publication
(10) Pub. No.: US 2015/0059408 A1
(43) Pub. Date: Mar. 5, 2015

(54) STRUCTURE PRINTER AND METHODS THEREOF

(71) Applicants: Evgeny ABUSHAEV, Ottawa (CA); Vladimir ANTONENKO, Moskovskaya Oblast (RU)

(72) Inventors: Evgeny ABUSHAEV, Ottawa (CA); Vladimir ANTONENKO, Moskovskaya Oblast (RU)

(21) Appl. No.: 14/019,403

(22) Filed: Sep. 5, 2013

(51) Int. Cl. E04B 1/76; C03B 19/08; C03B 19/02

(52) U.S. Cl. CPC E04B 1/7604; C03B 19/02; C03B 19/08
USPC 65/22; 65/181

(57) ABSTRACT

A structure printer for printing structures that has a stable platform on which a swiveling base is mounted. A boom is extendible from the base having a plasmatron mounted on the end of the boom for heating and melting the building material, which may subsequently be sprayed by a print head that receives the molten material from the plasmatron, the print head having an adjustable nozzle for expelling the mixture in a specific location. The printer may be vehicle-mounted, and may have a computer control so it is able to print a building faithfully from a blueprint. The building material may be foam glass, or other mixtures may be used.

### FIELD OF THE INVENTION

The invention relates to construction and in particular to a structure printer and method of use therefor.

### BACKGROUND OF THE INVENTION

Foam glass is an excellent bulk material for construction and for insulation purposes. It is a lightweight, expanded glass material with a closed-cell structure. It is typically made in molds that are packed with crushed or granulated glass mixed with a chemical agent such as carbon or limestone. Silica, which forms the main ingredient of glass, is present in sand. At the temperature at which the glass grains become soft enough to cohere, the agent gives off a gas that is entrapped in the glass and forms the closed-cell structure that remains after cooling. Foam glass is light enough to float in water and has been used as a substitute for cork, but its main uses are for thermal and sound insulation.

The pore size, and hence the density of the material, is partially adjustable by the expansion process parameters, in the range of 120 to 250 kg/m³, the material density ranges between 250 to 500 kg/m³. Since no diffusion can take place through the pores, the material is watertight and resistant to mold and rot. Foam glass has a high compression strength, is inert and durable against degradation, fire-resistant, odourless and has excellent insulating properties. Foam glass can be manufactured from waste glass, and is itself recyclable.

In the past foam glass has been used chiefly for insulation, where it may be administered as a free-flowing bulk material. Foam glass has also been used for lighter structural duties as it is rigid. However it has not yet successfully been used as a structural material that is pumped into place like concrete, for example, due to the difficulty in rendering the foam glass into a fluid state so that it may be pumped, among other issues.

In order to position concrete as a structural material, it is typically poured into molds, or when the desired location is not directly accessible by the cement truck, the cement can be pumped to the location by means of a boom pumping truck, which has pumping means to move the concrete through tubes, and a boom to position the outlet above the desired location. The typical application of concrete is by means of a boom controlled by the operator within the truck's cab, who controls the boom to place concrete at a certain location, or who is instructed to position the boom a certain way by workers on the ground.

### SUMMARY OF THE INVENTION

A printer for printing structures is disclosed, in a preferred embodiment using foam glass as a building material, and the printer has a stable platform on which a swiveling base is mounted. A boom is extendible from the base having a plasmatron mounted on the end of the boom for heating and melting a silica mixture, which may subsequently be sprayed by a print head having an adjustable nozzle to print a building. The printer may be vehicle-mounted, and may have a computer control so it is able to print a building faithfully from a blueprint.

### BRIEF DESCRIPTION OF THE FIGURES

FIG. 1 is an isometric view of the building printer mounted on a truck.

FIG. 2 shows a possible range of the building printer.

FIG. 3 further shows a possible range of the building printer

FIG. 4 is a detail sectional view of a print head that uses combustible gas.

FIG. 5 is a detail sectional view of a print head that uses a high voltage arc.

### DETAILED DESCRIPTION OF THE INVENTION

The present invention is a vehicle-based structure printer 1 that uses a boom 15 and a print head 25 for printing structures (not shown). A preferred building material is foam glass, however one skilled in the art would appreciate that other materials could be used for printing a structure. The vehicle 10 is moved to a location where it is desirable that a structure be built, and positioned stably and evenly nearby. The boom 15 has, at its end, a plasmatron and a print head. A source of sand having a heavy quartz content is available wherein the sand is sent up the boom to the plasmatron 20 mounted at the end of the boom 15. The plasmatron 20 mixes and superheats the sand and other additives, as needed to produce the desired material qualities. The appropriate quantity of the resulting molten slurry is then projected from the print head 25 into the desired location.

This slurry rapidly cools forming hardened foam glass where it was positioned, and the print head 25 can provide the foam glass slurry where necessary to fulfill the plans. In one embodiment, the movement of the print head 25 is computer controlled, such that the pivoting base 19, the boom 15, and the print head 25 are all controlled so as to be able to achieve a necessary position according to a controller implemented in hardware, software or firmware, or any combination thereof. Blueprints for the printing of a building may be designed using software such as AutoCAD™, Solidworks™ or the like.

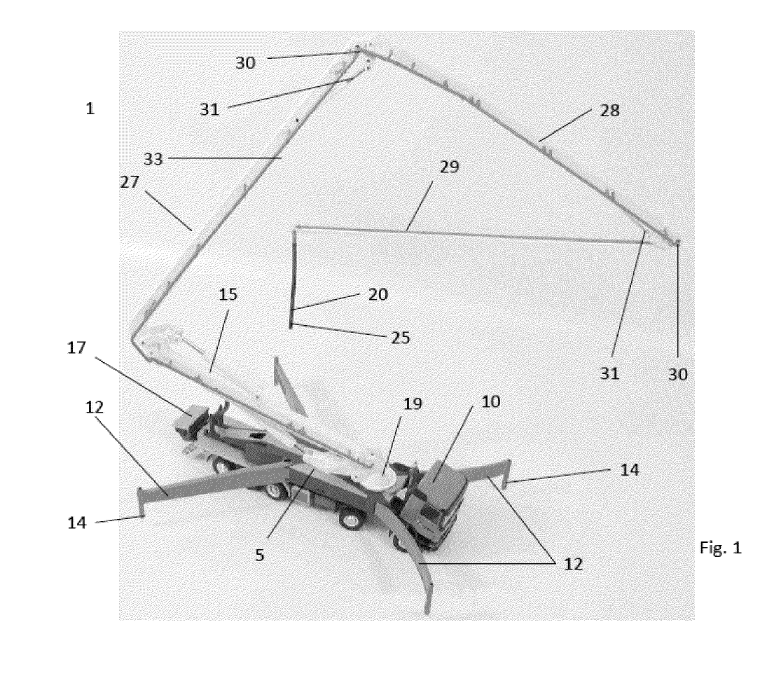

With reference to FIG. 1, the printer 1 is mounted on a mobile platform 5 positioned on a vehicle 10, for example a truck. Alternative vehicles to a truck are a ship, boat, train, or other vehicle, so long at the platform may be sufficiently stabilized to be able to accurately administer the molten foam glass. A stationary but relocatable platform 5 may also be used, which would be portable to other sites, as the buildings are to be printed in place. In the first embodiment, the truck is stabilized by means of four legs 12, which are extensible from the body of the truck 10. The legs 12 should be adjustable in height so that they are able to stabilize the truck 10 from movements of the boom 15, and over uneven ground. The legs 12 have extensible feet 14 which can accommodate uneven ground, and render the platform even and horizontal with the ground.

In one embodiment, the vehicle may also have an electronic system for evening out the platform and adjusting the feet 14, such that the platform is absolutely horizontal. In another embodiment, the platform may be slightly uneven, and the system is able to compensate for unevenness and adjust the settings of the controller (not shown) so that the boom is able to position the print head accurately despite unevenness. In another embodiment, laser leveling can be used, with the laser orienting itself by marks on rods positioned at the corners of the construction site, for example, or another standardized position. This is also known as a geopolar system of orientation for the site. GPS may also be used to orient the platform so that the controller is aware of its position with regards to the construction site, and the platform's orientation, such that it may be accommodated in printing the structure.

The vehicle has a generator 17 as a source of power for use in a remote location, or has access to a power supply for the power requirements of the plasmatron 20, in particular. The vehicle may also have a cabin or accommodations for the workers as the time to build a structure may be significant and the workers need facilities to rest.

Onto the platform 5 is mounted a swiveling base 19, from which base 19 the boom 15 extends. The base is capable of swiveling precisely, with a tolerance of 0.05 degrees, for example, such that it is capable of representing fine angular adjustments.

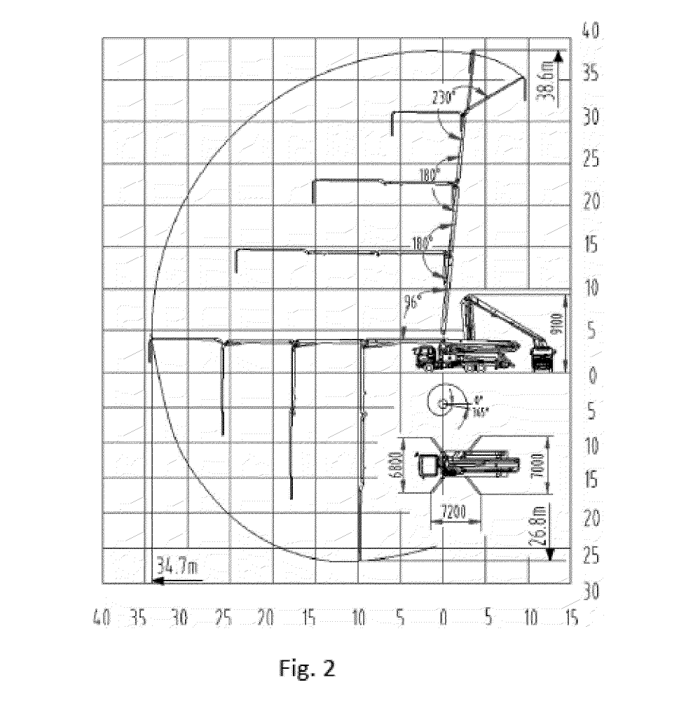

With reference to FIG. 2, in one embodiment the boom 15 is capable of extending through a range of 34.7 m and in height to 38.6 m (including the height of the platform 5. In another embodiment, and depending on the weight of the plasmatron 20 and the print head 25, the reach of the boom 15 may be more or less. A preferred embodiment for small structures would have a reach of approximately 15 m horizontally and 18 m vertically.

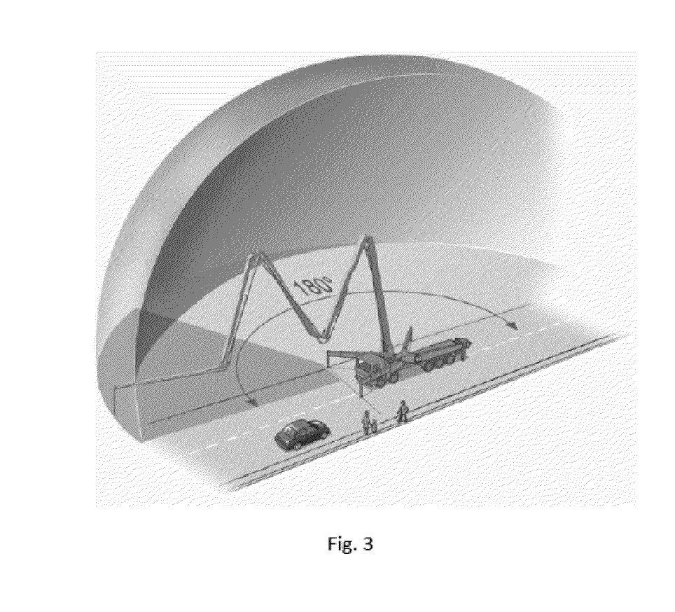

The boom 15 is made up of several sections 27, 28, 29 for instance, each connected to the previous section by means of a joint and a hydraulic jack, the jack is adjustable based on control from the vehicle. Such platform-mounted booms are known in the art, and are used for dispensing concrete, for example, in different locations in a construction project by pumping the concrete along the boom and out of a nozzle. By the combination of the pivoting base 19 and the extensible boom 15, an arc around the vehicle is reachable by the end of the boom, which is shown in FIG. 3.

In the present invention, a tube 33 is present along the boom 15 from the base 19 to the plasmatron 20. The tube 33 carries a mixture of silica and additives to the plasmatron 20, such that the mixture is combined and melted in the plasmatron to become liquid, to be passed into the print head to be subsequently dispensed in the appropriate location. The mixture is selected in advance to produce the correct consistency of foam glass. Sand of sufficient purity of silica may be substituted for silica, as may be recycled glass, crushed glass, and other sources of silica. Additive may include, but are not limited to, powder limestone and carbon. The mixture is in a powder form and may be propelled up the tube 33 by means of air pressure provided by fans or impellers (not shown) or other means known in the art, such that the silica and additive mixture is propelled to the plasmatron 20. It is possible to produce clear foam glass, which transmits some light, and colored varieties can be produced by adding dyes for example.

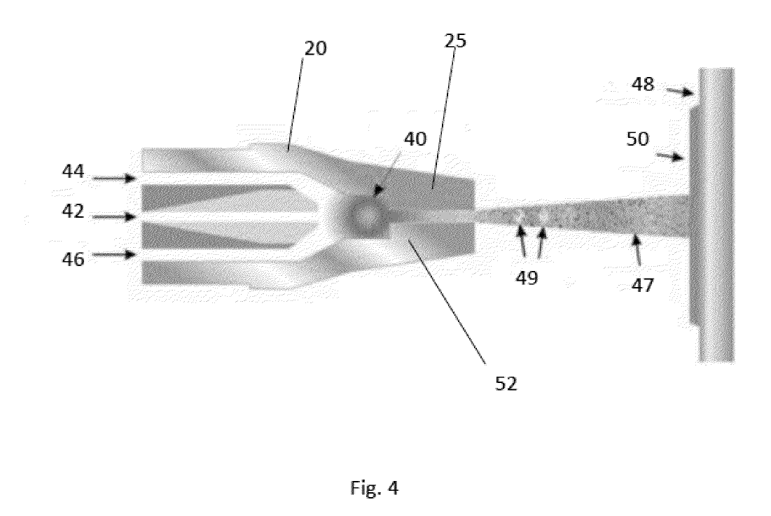

The high temperature of the plasmatron 20 to liquefy the silica mixture may be generated by combustion of a gas in the plasmatron, or by high-voltage. FIG. 4 shows an example plasmatron having a combustion chamber 40 where oxygen and a combustible gas burn to generate pressure and a high temperature. The silica mixture is projected into the combustion chamber along a powder path 42. The oxygen is delivered to the combustion chamber by means of an oxygen path 44, and the combustible gas is delivered by means of a gas path 46.

As the silica mixture passes through the combustion chamber 40 the heat fully or partially liquefies the silica mixture such that it combines to form a slurry 47 of foam glass, which molten slurry 47 then is projected from the nozzle 52 and impacts onto a previously-printed surface 48 for example, to build up the structure. It solidifies soon after impacting the surface due to the comparatively low temperature of the surface 48, which is at ambient temperature, and forms the new layer 50. The slurry may be only partially molten, having solid pieces 49 of the silica mixture within the slurry.

The plasmatron 20 consists of a high-temperature chamber wherein the mixture of silica and additives is introduced. The temperature is sufficiently high to melt the particles introduced, in the order of 5,000 to 13,000 degrees Celsius. The size of the pores, and therefore the density, is partially adjustable by varying the expansion process parameters.

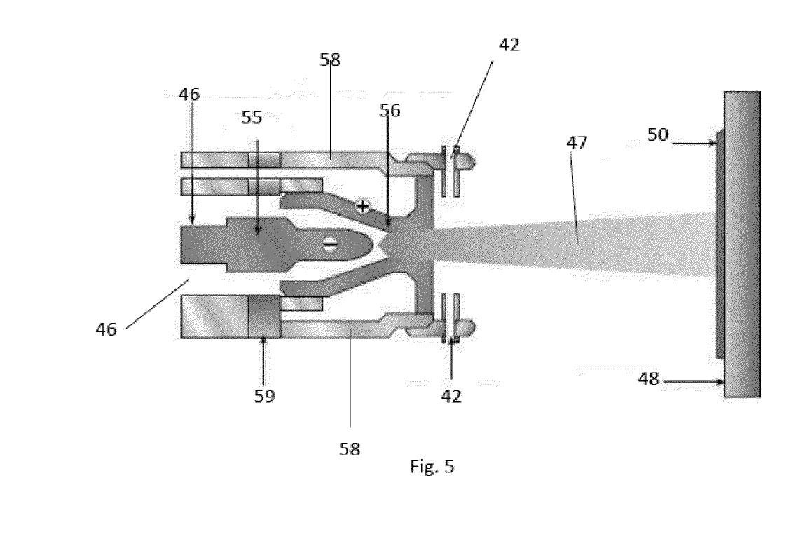

With reference to FIG. 5, in another embodiment the plasmatron 20 and print head 25 use plasma spraying wherein a cathode 55 is positioned in the center of the plasmatron 20, and an anode 56 is positioned adjacent but not touching the cathode 55 such that, with the application of a current to the cathode a high-temperature plasma arc is formed, with temperatures in the range of 5,000 to 13,000 degrees Celsius. In one embodiment the anode and cathode are water-cooled to prevent them from melting.

An inert gas such as helium, argon or nitrogen, for example, is passed at high pressure between the cathode and anode, through the gas path 46. The super-heated gas is then emitted from the nozzle 52 and projected towards the previously printed surface 48. Through the powder path 42, the silica mixture is introduced into the super-heated gas path, fully or partially liquefying the silia mixture, such that it forms foam glass.

The molten slurry 47 impacts the previously-printed surface 48 for example, to build up the structure. It solidifies soon after impacting the surface due to the comparatively low temperature of the surface 48, which is at ambient temperature, and forms the new layer 50. The nozzle 52 is adjustable for a finer or broader spray. The outer housing 58 of the plasmatron 20 is formed of insulating material, and the anode and cathode are insulated from their surroundings by insulators 59 as well, so as to prevent a short circuit or shock to operators.

Once molten, the foam glass mixture is emitted through the print head 25, which has a nozzle 52 that is adjustable for flow in one embodiment, such that a thin flow of molten foam glass may be applied, or a more substantial flow, depending on the requirements of the plan. The plasmatron 20 has computer managed temperature, pressure and speed of delivery, which enables the control of the density and volume of the dispensed foam glass.

Depending on the means for providing heat in the combustion chamber 40, lines for combustible gas (not shown) or electrical wires (not shown) run along the boom 15 from the base 19 to the plasmatron 20, in order to generate heat so the plasmatron 20 may liquefy the silica/additive mixture.

In order to print a structure, the printer 1 operates in a similar way to an ink jet printer, or a 3d printer, in that the print head is moved where it is required by the boom, and sprays a molten silica mixture that forms foam glass when it cools, in layers in order to build up material. The silica mixture is melted by the plasmatron, which is in fluid communication with the print head. A layer can be sprayed by the print head, that cools, after which the print head may spray another layer on top of the first to build up the material as necessary to fulfil the building plan. In a typical structural build, the foam glass printer 1 would print foam glass in a depth of about 20 cm to form a base, which would even out the terrain and produce a flat slab to be further built on.

The slab would be built of the densest foam glass, having a small pore size and therefore the greatest structural strength. The walls would then be printed from the edges of the slab. The printer follows a plan such as a blueprint and is operated by a controller. According to the blueprint, ducts can be printed into the structure, which would obviate the need for metal duct work therein as they are watertight and airtight where the foam glass is formed.

For faster printing, the print head may first print narrow walls around the volumetric spaces to be filled, and then widen the nozzle to permit greater volume, fill the space within the narrow walls so as to create a thicker wall.

Openings in the structure, such as windows, doors and ventilation, are printed for precise tolerances (the tolerance of the printer in one embodiment is 5 mm) such that the windows and doors may be fitted with a minimum of filler material, increasing the energy efficiency of the structure. Ventilation can also be printed, including the vents to the outside with fixtures therein, and the internal routing of ventilation, which replaces duct work through the space. As the foam glass is a good insulator, it keeps the cold air in the ventilation cold and the warm air warm.

To save cost on building materials and reduce weight of the structure, non-load bearing walls are made from lighter foam glass with larger pores, even though load bearing walls would require the denser and heavier foam glass. Insulation components adjacent to structural components contain more air, and are accordingly better insulating than the denser structural components.

Although the description above contains much specificity, these should not be construed as limiting the scope of the invention but as merely providing illustrations of the presently preferred embodiment of this invention. Thus the scope of the invention should be determined by the appended claims and their legal equivalents.

What is claimed is:

1. A structure printer for printing structures, the printer comprising:
a. a stable platform having mounted thereon a swiveling base;
b. a boom extendible from the base;
c. a plasmatron mounted on the end of the boom for melting a building material mixture; and
d. a print head mounted on the end of the boom adjacent the plasmatron, the print head in fluid communication with the plasmatron and having an adjustable nozzle for expelling the mixture in a specific location.

2. A method for printing a structure from a building material, comprising:
a. positioning a structure printer near a site;
b. melting a building material mixture in a plasmatron;
c. spraying the molten mixture from a print head;
d. repeating steps b and c as necessary to print a structure according to a plan.
